(19) United States
(12) Patent Application Publication
(10) Pub. No.: US 2005/0070334 A1
(43) Pub. Date: Mar. 31, 2005

(54) Cellular phone

(75) Inventors: Masako Ono, Kawasaki (JP); Kohhei Nakajima, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/859,239

(22) Filed: Jun. 3, 2004

(30) Foreign Application Priority Data
Sep. 25, 2003 (JP) 2003-429532

(51) Int. Cl. H04M 1/00

(52) U.S. Cl. 455/566; 455/575.1

(57) ABSTRACT

A cellular phone is provided that comprises a first housing having a first display unit, and a second housing having operation unit for operating display contents on the first display unit. The first housing and the second housing are foldably joined to each other via a joint portion. The second housing includes a second display unit disposed on the back of the operation unit.

### BACKGROUND OF THE INVENTION

1. Field of the Invention

The present invention relates to a cellular phone of which first and second display units are disposed on different housings.

2. Description of the Related Art

Currently, for cellular phones (including PHS (Personal Handyphone System)), a display unit such as a liquid-crystal screen is indispensable. This is because it acts as an interface when a user conducts various operations, such as making a telephone call (including videophone), reading a schedule book or an address book to check details, calling a menu for various settings, reading and writing a mail, browsing Web contents, viewing still images and moving images and others.

As shown in Japanese Patent Application Laid-Open Pub. No. 2002-281130, many of recent cellular phones are folding type which is provided with, in addition to a first display unit which is used for above operation, a second display unit on the back of the first display. The second display unit displays so-called status information such as a remaining level of a battery, an radio wave receiving condition, a date, an icon for indicating a setting status of the manner mode (a mode which notifies of an incoming call by means other than sound (vibration, light emitting and others)), an icon for indicating a setting status of an alarm, an icon for indicating presence of unanswered incoming calls (phone call, e-mail, facsimile and others), an icon for indicating presence of voice messages (messages left on an answering machine) and an icon for indicating being in the internet connection status; and so-called telephone-call (communication) information such as duration of a call (communication) and a charge for a call (communication). In this way, the user can see whether incoming calls are present or not even if the cellular phone is in a folded state, and the second display unit enhances convenience of the cellular phone.

As stated above, the cellular phone with the first and second display units is a main stream. In the future, as next-generation cellular phones which enable capable of high-speed communication become widespread, the cellular phones are used mainly as videophone terminals or viewing terminals for moving images such as movies and television programs, and it is expected that the display unit (especially, the first display unit) will be enlarged. FIGS. 1A and 1B are diagrams illustrating the cellular phones of which the first display unit is enlarged, and FIG. 1A is a front view and FIG. 1B is a back view. As shown in FIG. 1A, as a result of the enlargement of the first display unit 3, weight of a housing 1 which is provided with the first display unit 3 is increased, and since the overall cellular phone can not be supported if a housing 2 on which operation input keys 12 are disposed is gripped, the housing 1 is likely to be gripped, rather than the housing 2.

However, if a second display unit 4 is disposed on the back side of a first display unit 3 as in the conventional case, the second display unit 4 is covered by a hand for gripping a housing 1 which is provided with the first display unit 3, as shown in FIG. 1B, and in order to check the second display unit 4 on which duration of a call, a charge for a call and others are displayed on terminating call, a user have to change the gripping hand. It is not preferred to impose the extra operation of changing the gripping hand on users, and this fact may encourage the users to purchase other cellular phones when selecting merchandises.

### SUMMARY OF THE INVENTION

It is therefore the object of the present invention to provide a cellular phone which, even if its first display unit is enlarged for future application, allows its second display unit to be checked without changing the gripping hand when the telephone call is over.

In order to achieve the above object, according to the major aspect of the present invention there is provided a cellular phone comprising a first housing having a first display unit; and a second housing having operation unit for operating display contents on the first display unit, wherein the first housing and the second housing are foldably joined to each other via a joint portion, and wherein the second housing includes a second display unit disposed on the back of the operation unit.

Preferably, the first display unit has a display area larger than that of the second display unit. The cellular phone may further has a folding detection unit which detects whether the first housing and the second housing are in a folded state, and a control unit which controls display contents on the first and second display units. The control unit may determine whether or not the folding state is detected by the folding detection unit when a telephone call is over, the control unit if the folding state is detected by the folding detection unit displaying on the second display unit telephone-call information displayed at the end of the telephone call, the control unit if the folding state is not detected by the folding detection unit displaying the telephone-call information on the first display unit.

According to the present invention, a user can simultaneously enjoy a first advantage which is brought by being equipped with a first display unit (main screen) enlarged such as for using videophone on a large screen, for viewing movies and television programs on a large screen and for displaying a large size font to make texts easily viewable and a second advantage of being able to check a second display unit (sub-screen) without changing a gripping hand.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1A and 1B are diagrams illustrating a cellular phones of which the first display unit is enlarged;

FIGS. 2A to 2C are outside views of the cellular phone, which is in its folded state, of an embodiment of the present invention, FIG. 2A being a side view, FIG. 2B being a front view, and FIG. 2C being a rear view;

FIGS. 3A and 3B are outside views of the cellular phone, which is in its opened state, of the embodiment of the present invention, FIG. 3A being a side view and FIG. 3B being a front view;

FIG. 4 is a block diagram illustrating a configuration example of the cellular phone of the present embodiment;

FIG. 5 is a flowchart describing an example of the control operation of the display contents on the sub-screen of the cellular phone of the present embodiment; and

FIGS. 6A to 6E are outside views of a cellular phone of another embodiment of the present invention.

### DESCRIPTION OF THE PREFERRED EMBODIMENTS

Embodiments of the present invention will now be described with reference to the drawings. It is to be noted however that the technical scope of the present invention is not limited to these embodiments but covers the invention as defined in claims and equivalents thereof.

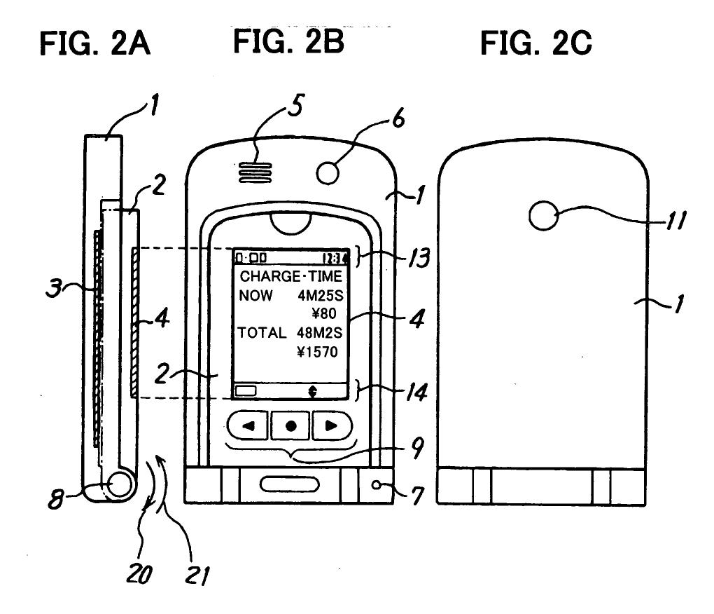

FIGS. 2A to 2C are outside views of a cellular phone (including PHS (Personal Handyphone System)) according to an embodiment of the present invention, which are diagrams illustrating a folded state. FIG. 2A is a side view; FIG. 2B is a front view; and FIG. 2C is a back view. As shown in FIG. 2A, a portion of a first housing 1 is notched, and by containing a second housing 2 in conformity with the notch, a thickness of the cellular phone in the folded state is reduced.

Before using, in the cellular phone in the folded state, by rotating the second housing 2 to a direction of an arrow 20, the cellular phone is released from the folded state, and a user can use the portable phone. After used, the user can put the cellular phone into the folded state again by rotating the second housing 2 to a direction of an arrow 21. Since the cellular phone in the folded state can be put in a small space, it is convenient to be carried, and when it is not used, the folded state is more convenient.

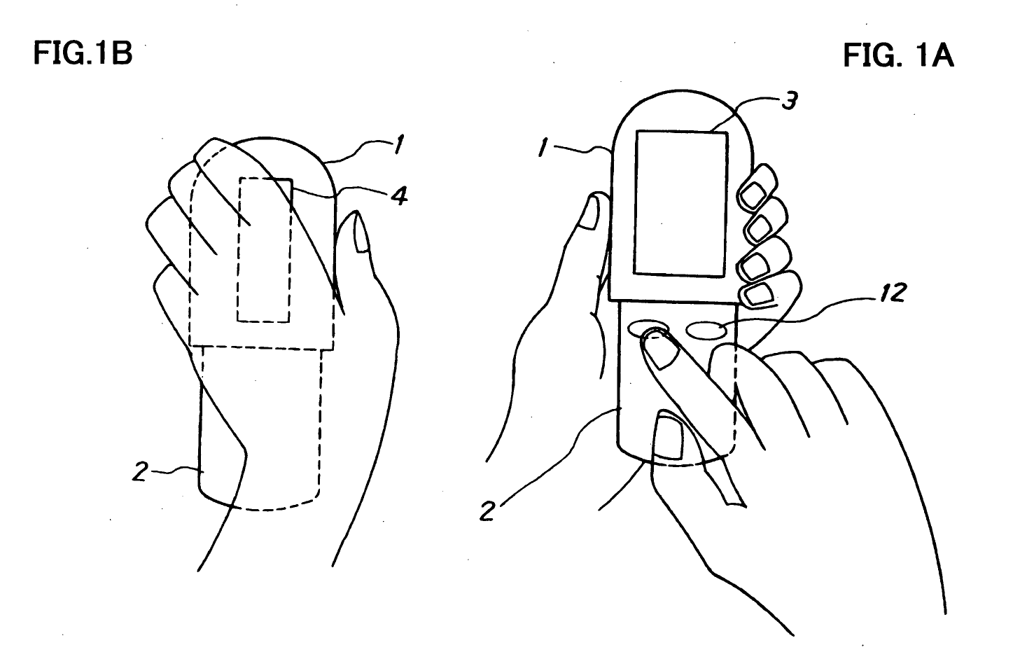

In the folded state, a sub-screen 4 provided on the back side of the second housing 2 comes into the user's sight. Therefore, after the telephone call or communication is over, by rotating the second housing 2 to the direction of the arrow 21, the user can check so-called telephone-call (communication) information such as duration of a call (communication) and a charge for a call (communication), which is displayed when the telephone call or communication is over, on the sub-screen 4. In addition, if the first housing 1 is gripped as shown in FIG. 1A, the user can check the sub-screen 4 without changing the gripping hand.

The second housing 2 is provided with buttons 9 for operating the display contents of the sub-screen 4, but the display contents of a main screen will not manipulated by the buttons 9, therefore the buttons 9 are different from operation input keys for operating the display contents of the main screen. The main screen is a display unit which is mainly used by the user when the cellular phone is used, and it is disposed at the position corresponding to main screen 3 of the first housing 1 of FIG. 1A, which is revealed by rotating the second housing 2 to the direction of the arrow 20. The sub-screen 4 may display a stand-by screen, or so-called status information such as a remaining level of a battery, an radio wave receiving condition, a date, an icon for indicating a setting status of the manner mode (a mode which notifies of an incoming call by means other than sound (vibration, light emitting and others)), an icon for indicating a setting status of an alarm, an icon for indicating presence of unanswered incoming calls (telephone call, e-mail, fax and others), an icon for indicating presence of voice messages (messages left on an answering machine) and an icon for indicating being in the internet connection status.

In FIG. 2C, a photography camera 11 provided on the back side of the first housing 1 is illustrated. Although the cellular phone is provided with a camera 6 which shooting the user's own face for sending to the other terminal when the videophone is used, the photography camera 11 is provided along with the camera 6 because a camera facing the outside is easier to use for shooting surrounding sceneries and persons, rather than the camera 6 shooting oneself for the videophone.

The position of the sub-screen 4 is a main concern in the present invention, and for describing this, the potable telephone which is released from its folded state or is in the opened state (unfolded state) will then be described.

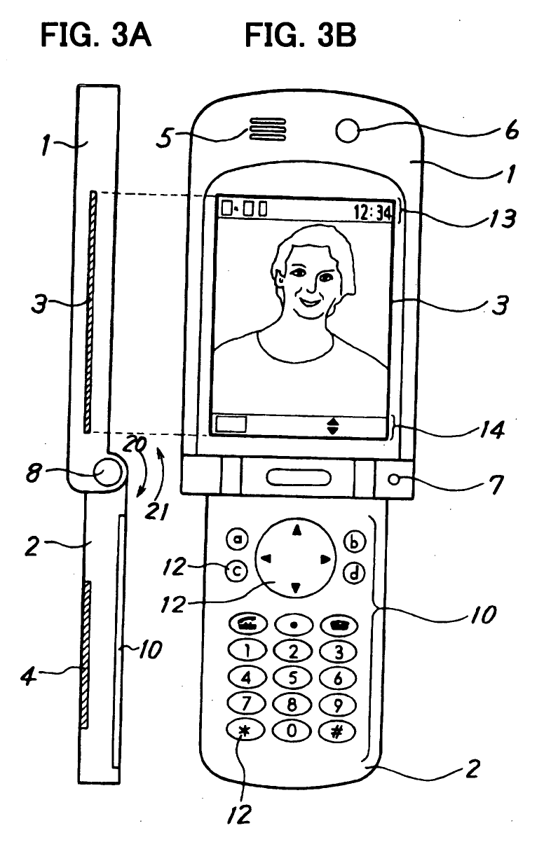

FIGS. 3A and 3B are outside views of a cellular phone (including PHS) of the embodiment of the present invention, which illustrate an unfolded state, i.e., open state. FIG. 3A is a side view, and FIG. 3B is a front view. As shown in FIG. 3A, the first housing 1 and the second housing 2 are joined via a hinge 8, and the folding can be achieved by rotating the second housing 2 which is in the state of being opened downward in FIGS. 3A and 3B to the direction of the arrow 21 though the hinge 8.

On the second housing 2, operation input keys 12, which is used for inputting details of instruction from the user when selecting a cellular phone operation menu displayed on the main screen 3 or when inputting telephone numbers, e-mail addresses or others at the time of making a call, are disposed such that these can be operated while watching the main screen 3. The operation input keys 12 include an arrow key, a power key, a telephone-call starting key, a dial number key and others. An operation unit 10 is formed with a plurality of operation input keys 12.

The embodiment of the cellular phone of the present invention is characterized in that the second housing 2 is equipped with the sub-screen 4 on the back side of the operation unit 10. As shown in FIG. 3A, the operation unit 10 is disposed such that the characters printed on the operation input keys (numeral numbers for dialing, button symbols and others) face the outside in the state that the cellular phone is opened, and the sub-screen 4 is also disposed such that a display surface faces the outside in the state that the cellular phone is opened. Both of these are characterized by being disposed on the surfaces of the second housing, which are opposed to each other. Further, the sub-screen 4 is a screen which can be visually recognized by the user in the folded state, as described with FIGS. 2A to 2C.

In this way, by disposing the operation unit 10 and the sub-screen 4 on the surfaces of the second housing 2, which are opposed to each other, and by being able to visually recognize the sub-screen even in the folded state, for example after enjoying calls by videophone with the main screen 3, the user can fold the cellular phone and check telephone-call information with the sub-screen without changing the gripping hand, and this is very convenient.

Other portions of FIG. 3 are also described. The main screen 3 provided on the first housing 1 displays a menu for operating the cellular phone and contents corresponding to the selected menu. As examples of the contents, e-mails, Web contents, still images, moving images, setting modification screen of the cellular phone and others can be cited, and in FIG. 3B, the moving image taken by the other calling terminal when videophone is used (face of the other calling party) is displayed on the main screen 3, as an example.

In the present embodiment, these contents can be viewed on the main screen 3 larger than the conventional type. If the font size displayed on the main screen 3 is enlarged, texts become easier to be viewed. Because the main screen 3 is enlarged, if the font size is enlarged, the number of displayed characters is increased, so this is user friendly. When telephone calls or e-mails are sent or received, information on the destination of the transmission (telephone numbers or e-mail addresses) is displayed on the main screen 3, and the status information 13 or the guidance information 14 which indicates functions allocated to the operation input keys 12 are also displayed.

The cellular phone of the present embodiment is also provided with a speaker 5, the camera 6 which takes images from the own terminal (face of oneself) when videophone is used, a microphone 7 and a communication antenna (not shown) and can perform voice-only calls and calls based on the videophone function using voices and images, reception of the Web contents and transmission and reception of e-mails.

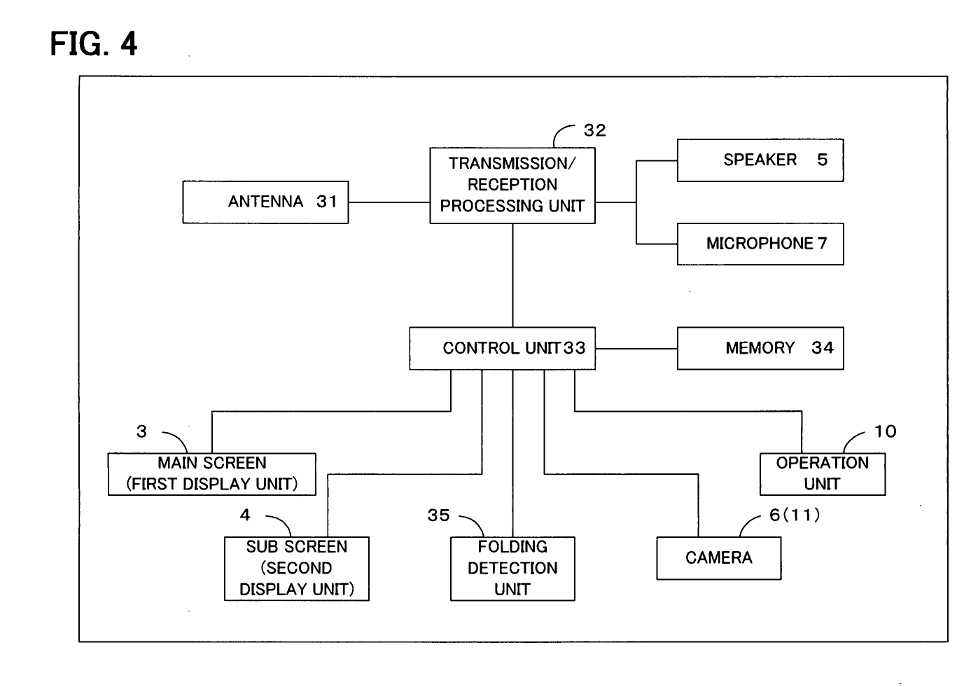

FIG. 4 is a block diagram illustrating a configuration example of the cellular phone (including PHS) of the present embodiment. The present embodiment is comprised of an antenna 31, a transmission and reception processing unit 32, a speaker 5, a microphone 7, control unit 33, a memory 34, the main screen 3, the sub-screen 4, a folding detection unit 35, the camera 6 (11) and the operation unit 10.

The antenna 31 performs transmission and reception of radio waves with a base station. The transmission and reception processing unit 32 modulates voices for transmission input through the microphone 7 and data input via the operation unit 10 to output to the antenna 31 and demodulates radio waves received from the antenna 31 to output to the speaker 5.

The control unit 33 includes CPU, which controls the transmission and reception processing unit 32, the main screen 3, the sub-screen 4, the folding detection unit 35, the camera 6 (11), the operation unit 10 and the memory 34, and ROM, which stores information necessary for control. The main screen 3 and the sub-screen 4 are, for example, display units such as a liquid-crystal display and display various information on the cellular phone. The memory 34 stores operation data used by the control unit 33, incoming-call information for displaying the incoming-call history and others. The folding detection unit 35 is means for detecting whether it is in the folded state or the opened state as well as changes of the states, utilizing a light sensor, magnets, angles of the hinge, or others. The display contents on the sub-screen 4 are controlled by the control unit 33, and an example of the control operation is then described.

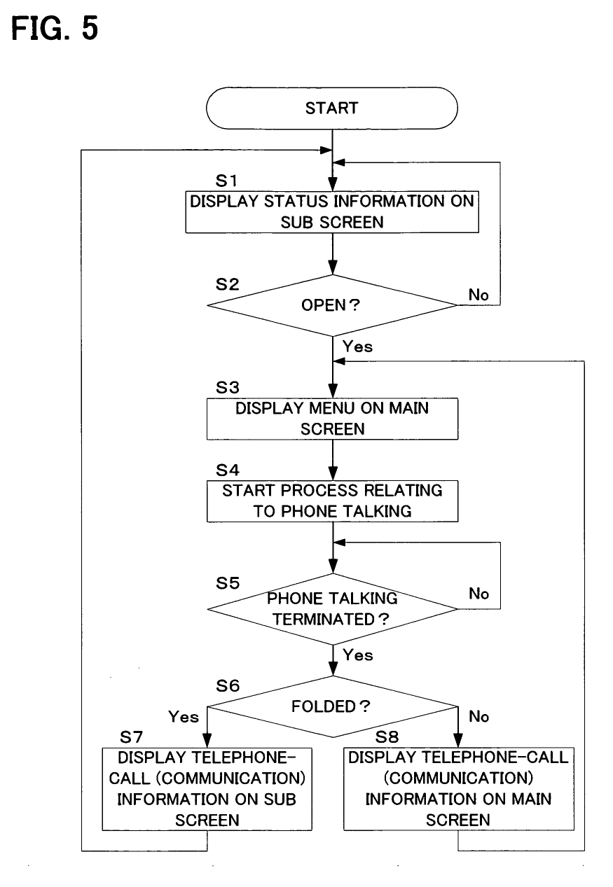

FIG. 5 is a flowchart describing the example of the control operation of the display contents on the sub-screen 4 of the cellular phone (including PHS) of the present embodiment. At the start of this flow, the cellular phone is assumed to be in the folded state, and this is an example in the case of using telephone function based on voices. In the folded state, the sub-screen displays the status information 13 (S1). When the folding detection unit detects that the folded state is changed to the opened state of FIG. 3 (S2 Yes), it is determined that the cellular phone is to be used, and the control unit 33 displays a menu stored in ROM on the main screen 3.

If the change to the opened state is not detected (S2 No), the cellular phone is not yet used, returning to step S1. The user then selects a telephone from the menu, and a telephone call begins (S4). When detected that the telephone call is over (S5 Yes), the control unit 33 determines whether it is in the folded state or not (S6). To detect that the telephone call is over, it may be possible to detect that a telephone-call ending key included in the operation input keys is pushed.

If it is in the folded state at the time of end of the telephone call (S6 Yes), the control unit 33 displays the telephone-call information on the sub-screen 4 (S7), and return to step S1. The case of being in the folded state at the time of end of the telephone call happens, for example, in the cellular phone having a function in which the changing from the opened state to the folded state is considered as end of the telephone call. If it is in the opened state at the time of end of the telephone call (S6 No), the control unit 33 displays the telephone-call information on the main screen 3 (S8), and then return to step S3. In each step which displays information on the screens (S1, S3, S7 and S8), after a predefined amount of time has passed, the control unit 33 may perform control such that the display is changed to predefined stand-by screen for saving electric power.

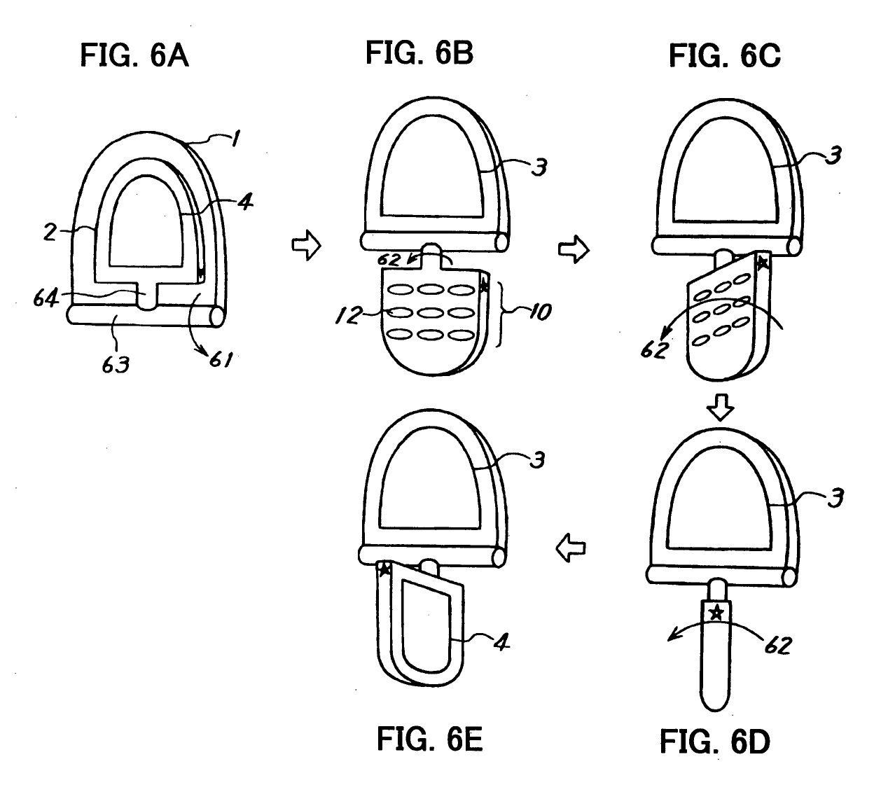

FIGS. 6A to 6E are outside views of a cellular phone (including PHS) of another embodiment of the present invention. FIG. 6A illustrates the cellular phone in the folded state. The first housing 1 and the second housing 2 are joined via a joint portion 63 which can turn to a direction of an arrow 61, and in FIG. 6A, it is in the folded state, in which it is folded in the state that the sub-screen 4 provided on the second housing 2 can be visually recognized.

FIG. 6B is a diagram illustrating a state that the cellular phone is opened by turning the second housing 2 to the direction of the arrow 61. In the state that the cellular phone is opened, the operation input keys 12 disposed on the second housing 2 can be identified. The operation unit 10 is formed with a plurality of operation input keys 12. The first housing 1 and the second housing 2 are further joined via a joint portion 64 which can turn to a direction of an arrow 62.

From FIG. 6C to FIG. 6E are diagrams illustrating how the second housing 2 is turned to the direction of the arrow 62. Illustrated are how the sub-screen 4 disposed on the back side of the operation unit 10 can be visually recognized finally, as the second housing 2 is turned to the direction of the arrow 62.

By using the cellular phone of FIG. 6, the sub-screen can be checked in the folded state as well as in the opened state. Further, when checked, the second housing 2 can be turned by a hand which is not the hand gripping the first housing 1, and again, the sub-screen 4 can be checked without changing the hand gripping the first housing 1.

As stated above, according to the cellular phone (including PHS) of the present invention, the user can simultaneously enjoy a first advantage which is brought by being equipped with the first display unit (main screen) enlarged such as for using videophone on a large screen, for viewing movies and television programs on a large screen and for displaying with a large size font to make texts easily viewable and a second advantage of being able to check the second display unit (sub-screen) without changing the gripping hand.

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1. A cellular phone comprising:
a first housing having a first display unit; and
a second housing having operation unit for operating display contents on the first display unit, wherein
the first housing and the second housing are foldably joined to each other via a joint portion, and wherein
the second housing includes a second display unit disposed on the back of the operation unit.

2. The cellular phone according to claim 1, wherein
the first display unit has a display area larger than that of the second display unit.

3. The cellular phone according to claim 1, further comprising:
a folding detection unit which detects whether the first housing and the second housing are in a folded state, and
a control unit which controls display contents on the first and second display units, wherein the control unit:
determines whether or not the folding state is detected by the folding detection unit when a telephone call is over;
displays on the second display unit telephone-call information displayed at the end of the telephone call if the folding state is detected by the folding detection unit; and
displays the telephone-call information on the first display unit if the folding state is not detected by the folding detection unit.
